(19) United States
(12) Patent Application Publication
(10) Pub. No.: US 2026/0228020 A1
(43) Pub. Date: Aug. 6, 2026

(54) UNIFIED COMPUTING INTERFACE FOR AI/ML WORKLOADS

(71) Applicants: Gaurav Vij, New Delhi (IN); Saurabh Kumar Vij, Mississauga (CA)

(72) Inventors: Gaurav Vij, New Delhi (IN); Saurabh Kumar Vij, Mississauga (CA)

(21) Appl. No.: 18/951,628

(22) Filed: Nov. 18, 2024

Related U.S. Application Data
(60) Provisional application No. 63/599,562, filed on Nov. 16, 2023.

(51) Int. Cl. G06F 9/451; G06N 20/00

(52) U.S. Cl. CPC G06F 9/451; G06N 20/00

(57) ABSTRACT

A distributed computing system for artificial intelligence workloads, comprising: a core orchestration server configured to manage a network of heterogeneous computing devices; a node registration module configured to detect capabilities of computing devices and register validated devices as network nodes; a security layer implementing authentication and workload isolation protocols; a workload scaling module configured to match job requirements with available node capabilities and distribute tasks across the network nodes; a smart container orchestrator configured to deploy and monitor containerized AI/ML workloads across the network nodes; wherein said system enables distributed processing of AI/ML workloads across heterogeneous computing devices.

### CLAIM OF PRIORITY

This application claims priority to U.S. Provisional Application No. 63/599,562, titled UNIFIED COMPUTING INTERFACE FOR AI/ML WORKLOADS and filed on Nov. 16, 2023. This provisional application is hereby incorporated by reference in its entirety.

### BACKGROUND

The explosive growth in AI/ML applications has created an unprecedented demand for computational resources, particularly GPU computing power, leading to significant cost and availability challenges for developers and organizations. Traditional cloud computing providers offer AI/ML infrastructure at premium prices, making it financially prohibitive for many organizations to scale their AI operations, especially during training and fine-tuning of large models. Meanwhile, there exists a vast untapped computational resource in the form of consumer-grade hardware, including gaming consoles, crypto mining rigs, and high-end personal computers, which often sit idle or underutilized. Additionally, there is growing trend of AI model fine-tuning and adaptation requires significant computational resources, yet many of these operations could theoretically run on consumer-grade GPUs if properly orchestrated and optimized. Current solutions for distributed computing either lack the sophistication to handle AI/ML workloads effectively or require significant technical expertise to implement and manage, creating a barrier for many potential users. The rise of techniques like LoRA (Low-Rank Adaptation) has demonstrated that efficient model training and fine-tuning can be accomplished with less powerful hardware than previously thought possible, opening new possibilities for distributed computing. Organizations face challenges in maintaining high availability and fault tolerance for AI/ML workloads while managing costs, creating a need for systems that can automatically scale and optimize resource usage. Moreover, there is some success of decentralized systems in other domains suggests that a similar approach could revolutionize AI/ML computing by creating a more accessible and cost-effective infrastructure. The increasing demand for edge computing and local AI processing creates a need for systems that can effectively manage and orchestrate distributed computational resources. In this way, there is a need to address the gap between the high costs of traditional AI infrastructure and the availability of underutilized consumer hardware presents an opportunity to create a more democratic and accessible platform for AI/ML development.

### SUMMARY OF THE INVENTION

A distributed computing system for artificial intelligence workloads, comprising: a core orchestration server configured to manage a distributed network of heterogeneous computing devices; a node registration module configured to detect capabilities of computing devices requesting to join the network, perform automated benchmarking of said computing devices, and register validated devices as network nodes; a security layer implementing TLS certification, node authentication protocols, and workload isolation protocols; a workload scaling module configured to analyze job requirements, match said requirements with available node capabilities, and distribute tasks across the network nodes; a smart container orchestrator configured to deploy containerized AI/ML workloads, monitor workload execution, and maintain workload operations across the network nodes; wherein said system enables distributed processing of AI/ML workloads across heterogeneous computing devices.

### BRIEF DESCRIPTION OF THE DRAWINGS

FIG. 1 is an illustration of a system for unified computing interface for AI/ML workloads, according to an exemplary embodiment.

FIG. 2 illustrates another example system for unified computing interface for AI/ML workloads, according to some embodiments.

FIG. 3 illustrates an example process, according to some embodiments.

FIG. 4 depicts an exemplary computing system that can be configured to perform any one of the processes provided herein.

FIG. 5 illustrates an example Unified Computing Interface System for implementing a Unified Computing Interface for AI/ML Workloads, according to some embodiments.

FIG. 6 illustrates an example process for implementing a decentralized network of heterogeneous nodes, according to some embodiments.

FIG. 7 illustrates an example process for implementing a Workload Scaling Module, according to some embodiments.

FIG. 8 illustrates an example process for Smart Container Orchestration, according to some embodiments.

FIG. 9 illustrates an example process for pre-processing pipeline implementations.

Unified Computing Interface System can manage several layers of performance optimization as shown in FIG. 10, according to some embodiments.

The Figures described above are a representative set and are not an exhaustive with respect to embodying the invention.

### DESCRIPTION

Disclosed are a system, method, and article of manufacture of unified computing interface for AI/ML workloads. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Application programming interface (API) is a way for two or more computer programs to communicate with each other. An API can be a type of software interface, offering a service to other pieces of software. A document or standard that describes how to build or use such a connection or interface is called an API specification. A computer system that meets this standard is said to implement or expose an API. In some examples, the term API may refer either to the specification or to the implementation.

Deep learning can be a machine learning method(s) based on artificial neural networks with representation learning. Deep learning can use multiple layers in the network. Methods used can be either supervised, semi-supervised or unsupervised. Deep-learning architectures such as deep neural networks, deep belief networks, deep reinforcement learning, recurrent neural networks, convolutional neural networks and transformers.

Generative artificial intelligence is artificial intelligence capable of generating text, images, or other media, using generative models. Generative AI models learn the patterns and structure of their input training data and then generate new data that has similar characteristics. Generative model is a statistical model of the joint probability distribution P(X, Y) on given observable variable X and target variable Y. Example generative classifiers can include, inter alia: naive Bayes classifier and linear discriminant analysis.

Graphics processing unit (GPU) is a specialized electronic circuit initially designed to accelerate computer graphics and image processing (e.g. on a video card or embedded on the motherboards, mobile phones, personal computers, workstations, and game consoles).

Heterogeneous network is a network connecting computers and other devices where the operating systems and protocols have significant differences.

Low-Rank Adaptation (LoRA) is a technique used to reduce the cost of fine-tuning large language models (LLMs) to a fraction of its actual figure. LoRA is a training method that accelerates the training of large models while consuming less memory. LoRA freezes the pre-trained model weights and injects trainable rank decomposition matrices into each layer of the Transformer architecture, greatly reducing the number of trainable parameters for downstream tasks.

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Service-level agreement (SLA) is an agreement between a service provider and a customer. Particular aspects of the service (e.g. quality, availability, responsibilities, etc.) are agreed between the service provider and the service user.

Stable Diffusion is a deep learning, text-to-image model released in 2022 based on diffusion techniques. It is primarily used to generate detailed images conditioned on text descriptions, though it can also be applied to other tasks such as inpainting, outpainting, and generating image-to-image translations guided by a text prompt.

Whisper is a weakly-supervised deep learning acoustic model for speech recognition made by the company OpenAI.

### Example Embodiments

Embodiments of a method, system, techniques, a device, or an apparatus for a unified computing interface for AI/ML workloads are now described. Embodiment can utilize various techniques/systems, including, inter alia: UCI Smart Orchestrator: Heterogenous nodes: Crypto mining rigs, Data Centers, PlayStation, X Box, Tesla Cars Scalability API layer Abstraction method Fine-tuning Security Auto Batch Sizing, etc.

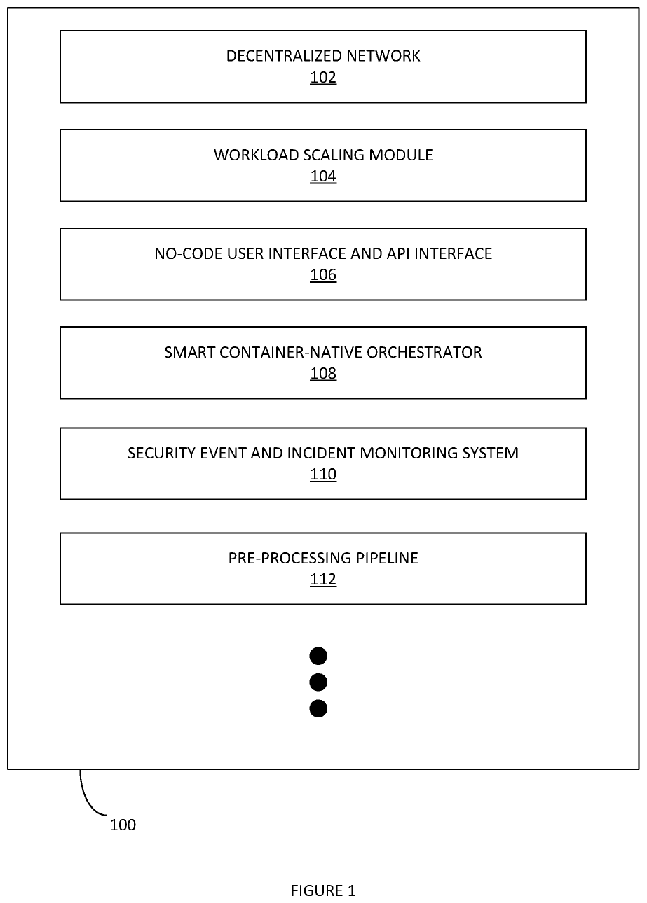

FIG. 1 is an illustration of a system 100 for a, according to an exemplary embodiment. A decentralized network 102 can comprise a plurality of heterogeneous nodes such as, inter alia: crypto mining rigs, data centers, play stations, x box, tesla cars, etc. A workload scaling module 104 to implement and manage an easy, scalable and reliable system to deploy workloads on such heterogenous nodes without compromising security and performance. A no-code user interface and API interface 106 that allows developers to deploy AI/ML workloads such as training, fine-tuning and model deployment jobs.

A smart container-native orchestrator 108 that accepts the jobs from developers and deploys them on our decentralized network of nodes in a scalable, cost efficient and fault tolerant manner. A security event and incident monitoring system 110 that monitors any security related issues and ensures the jobs are not failing by adding fault tolerance and data/node replication as a failover.

A pre-processing pipeline 112 that optimizes models for inference using optimization techniques like pruning, quantization and knowledge distillation and pre-configures the environment for fine-tuning models by automatically figuring out optimal hyper-parameters and the batch size required for fitting the model and dataset in given GPU memory to avoid out of memory issues. Additionally system 100 can use techniques like LoRA for parameter efficient finetuning and fitting the models and the datasets in smaller GPU memory leading to higher cost savings.

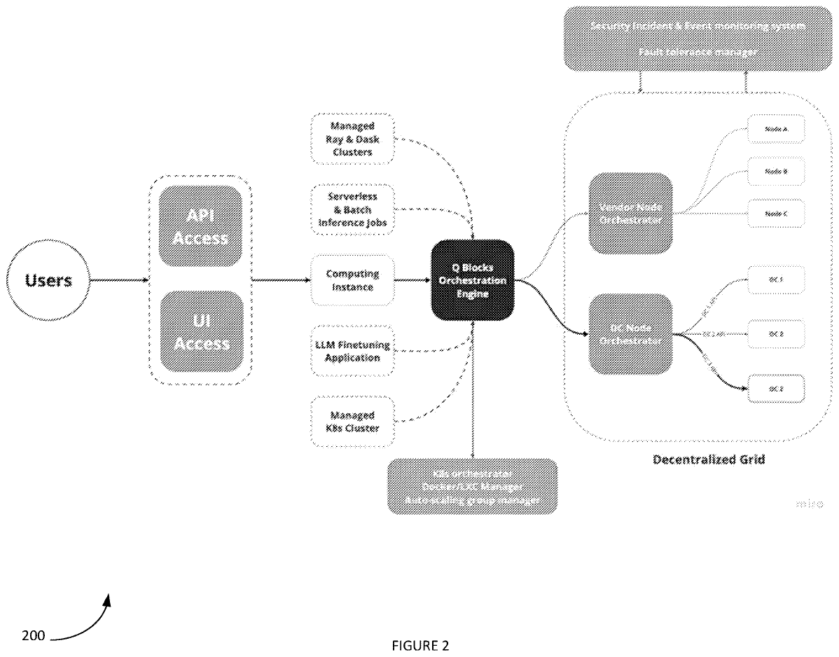

FIG. 2 illustrates another example system for unified computing interface for AI/ML workloads, according to some embodiments. System 200 can provide a decentralized network of heterogeneous nodes working in a scalable and fault tolerant manner. System 200 can deploy and build AI/ML models on consumer grade machines. System 200 can make consumer grade machines run business applications.

System 200 can provide ease of use for developers through a no-code and pre-configured template implementation. System 200 can provide cost efficiency improvements by combining model optimization with low-cost consumer grade machines at scale. System 200 can provide an always available infra capability for production grade workloads by leveraging low-cost infrastructure to serve as fault tolerance and warmed up systems.

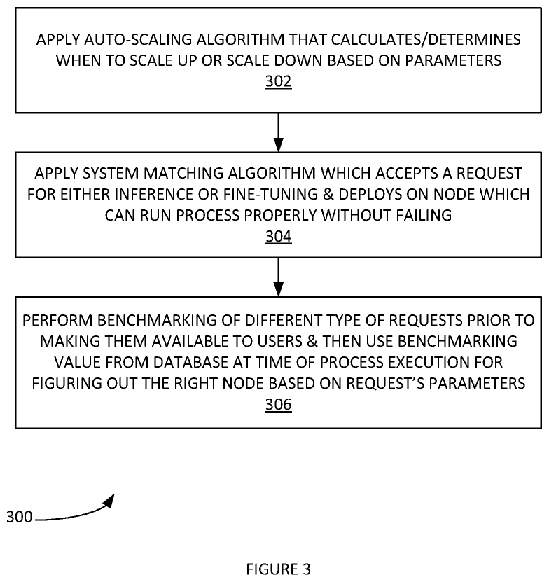

FIG. 3 illustrates an example process 300, according to some embodiments. In step 302, process 300 can apply an auto-scaling algorithm that calculates/determines when to scale up or scale down based on parameters. These parameters can include, inter alia: network traffic, available GPU supply on the network, keeping a track of which supplier can provide how many GPUs, matching the right system with the requirement.

In step 304, process 300 can apply a system matching algorithm which accepts a request for either inference or fine-tuning and then deploys it on a node or a cluster of nodes which can run the process properly without failing. Here, process 300 can perform a benchmarking of different type of requests prior to making them available to users and then using that benchmarking value from the database at the time of process execution for figuring out the right node based on the request's parameters in step 306.

In one example, a Stable Diffusion XL (SDXL) API may need a minimum 16GB GPU while a Whisper model can work on 8GB GPUs. Depending on the factors like available quantity and type of nodes, traffic on the network, process 300 can spin up and re-provision nodes to deliver a target SLA of 1 minute.

### Additional Example Machine Learning Implementations

Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning. Random forests (RF) (e.g. random decision forests) are an ensemble learning method for classification, regression and other tasks, which operate by constructing a multitude of decision trees at training time and outputting the class that is the mode of the classes (e.g. classification) or mean prediction (e.g. regression) of the individual trees. RFs can correct for decision trees'habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (for example in cross-validation), the test dataset is also called a holdout dataset.

### Additional Example Computing Systems

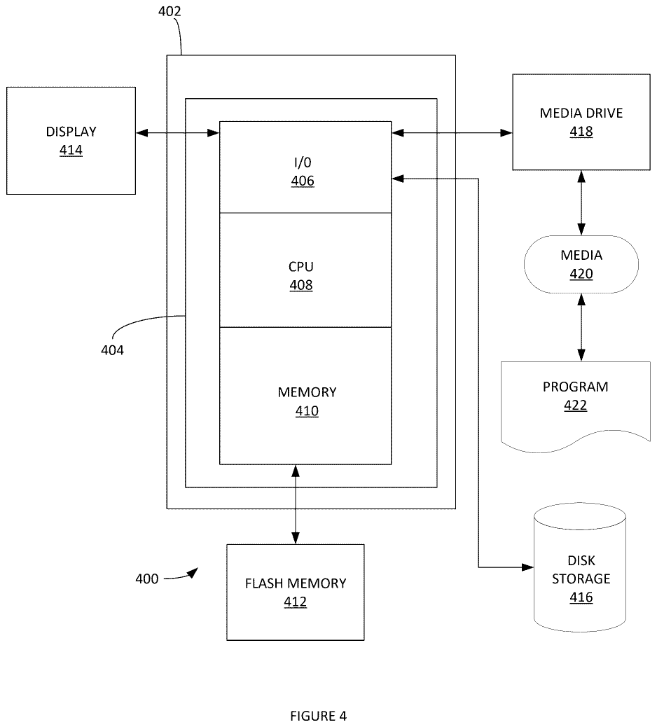

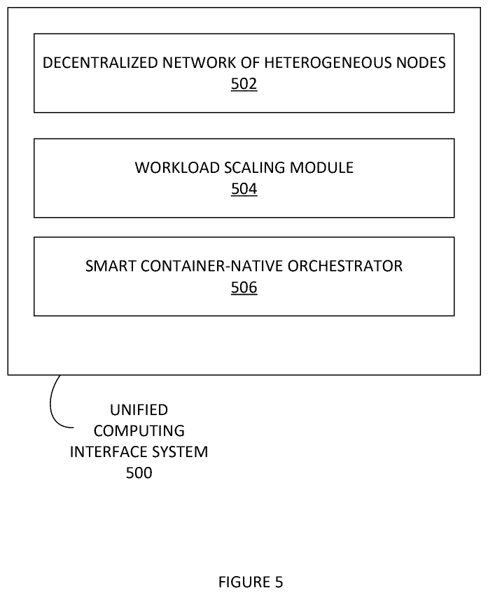

FIG. 4 depicts an exemplary computing system 400 that can be configured to perform any one of the processes provided herein. In this context, computing system 400 may include, for example, a processor, memory, storage, and I/O devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

FIG. 5 illustrates an example Unified Computing Interface System 500 for implementing a Unified Computing Interface for AI/ML Workloads, according to some embodiments. Unified Computing Interface System 500 provides a significant advancement in distributed computing architecture. In an example practical implementation of the Unified Computing Interface System 500 uses three primary architectural pillars. The first pillar consists of the decentralized network of heterogeneous nodes 502. This include consumer-grade hardware such as gaming consoles, crypto mining rigs, and various computational devices. The second pillar encompasses the workload scaling module 504. This manages resource allocation and deployment across the network. The third pillar comprises the smart container-native orchestrator 506 that handles job distribution and execution.

Decentralized Network Implementation with a decentralized network of heterogeneous nodes 502 is now discussed. decentralized network of heterogeneous nodes 502 can use careful consideration of node diversity and capability management. Each participating node in the network must run a base software stack that includes container runtime support, GPU drivers where applicable, and networking components for secure communication. decentralized network of heterogeneous nodes 502 implements a node registration protocol that accomplishes several critical tasks.

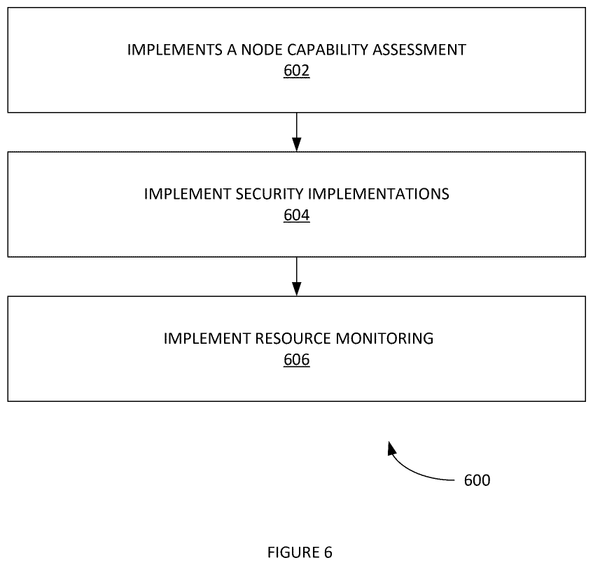

FIG. 6 illustrates an example process 600 for implementing a decentralized network of heterogeneous nodes, according to some embodiments. In step 602 process 600 implements a Node Capability Assessment. When a new node joins the network, the system performs comprehensive benchmarking to determine its computational capabilities, memory constraints, and network performance characteristics.

In step 604, process 600 implements Security Implementations. Each node establishes secure communication channels using TLS certificates and implements network isolation for workload protection.

In step 606, process 600 implements Resource Monitoring. Continuous monitoring systems track node availability, performance metrics, and reliability statistics to inform workload placement decisions.

Workload Scaling Module 504 is now discussed. Workload Scaling Module 504 represents the intelligent core of the system, implementing sophisticated algorithms for resource management and job distribution. Workload Scaling Module 504 implements several key functionalities.

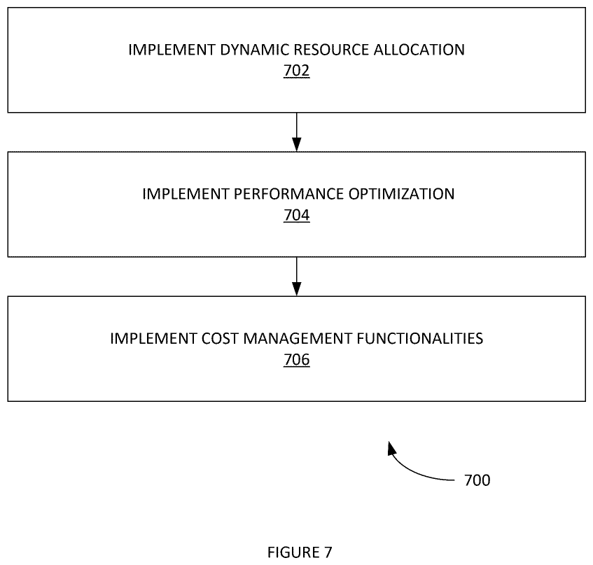

FIG. 7 illustrates an example process 700 for implementing a Workload Scaling Module 504, according to some embodiments. In step 702, process 700 implements Dynamic Resource Allocation. Workload Scaling Module 504 maintains a real-time inventory of available computational resources across the network, implementing priority queues and resource reservation systems for different workload types.

In step 704 process 700 implements Performance Optimization. Here, advanced algorithms analyze historical performance data to optimize workload placement, considering factors such as node reliability, network latency, and computational efficiency. In step 706, process 700 implements Cost Management functionalities. Workload Scaling Module 504 implements sophisticated cost modeling to optimize resource utilization while maintaining performance requirements within specified SLA parameters.

Smart Container Orchestration 506 is now discussed. Smart Container Orchestration 506 implements a custom scheduler designed specifically for AI/ML workloads. This component includes several sophisticated features.

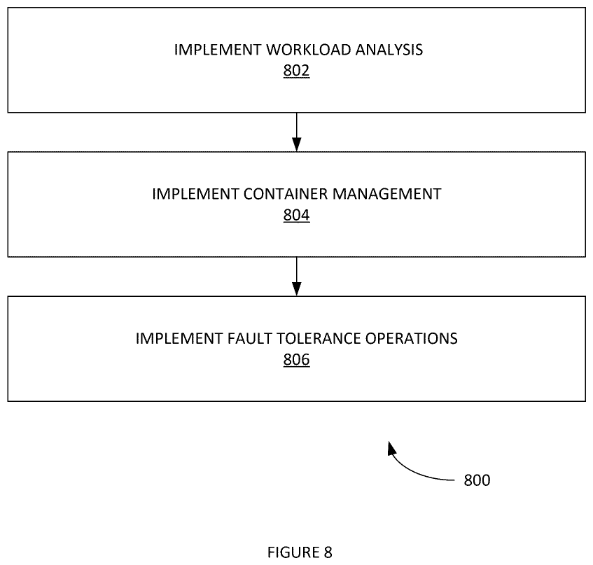

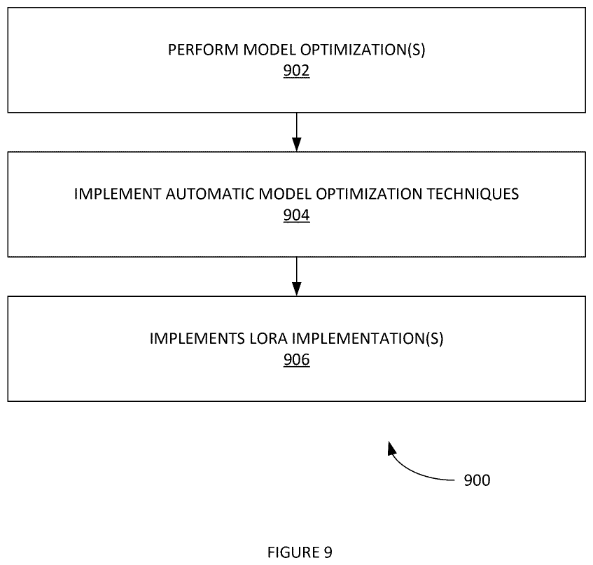

FIG. 8 illustrates an example process 800 for Smart Container Orchestration 506, according to some embodiments. In step 802, process 800 implements Workload Analysis. Smart Container Orchestration 506 implements automatic workload classification to determine resource requirements and optimal placement strategies.

In step 804, process 800 implements Container Management. Advanced container lifecycle management handles deployment, scaling, and cleanup operations across the heterogeneous network. In step 806, process 800 implements Fault Tolerance operations. The system implements multiple layers of fault tolerance, including automatic failover, workload checkpointing, and state management across distributed nodes.

Unified Computing Interface System 500 can perform other operations such as, inter alia, Security Implementations. The security implementation encompasses multiple layers of protection. For example, Network Security can manage secure communication channels using industry-standard encryption and authentication protocols. Unified Computing Interface System 500 perform workload Isolation. Container-level security implementations ensure workload isolation and data protection. Unified Computing Interface System 500 can perform Access Control. Sophisticated role-based access control systems manage user permissions and resource allocation. Unified Computing Interface System 500 can perform Monitoring and Response operations. Real-time security monitoring systems detect and respond to potential threats or anomalies.

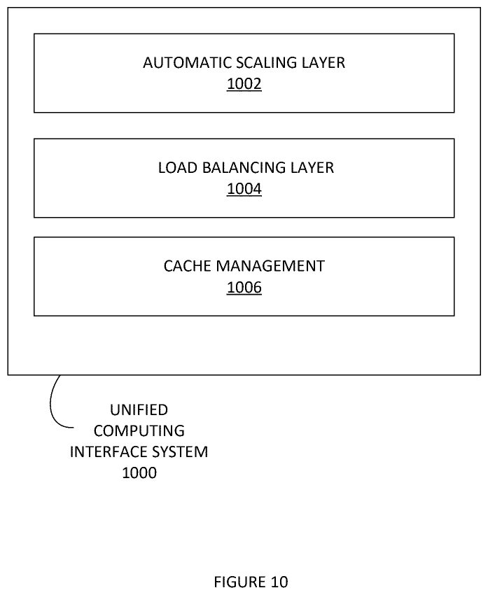

Unified Computing Interface System 500 can perform pre-processing pipeline Implementations. FIG. 9 illustrates an example process 900 for pre-processing pipeline implementations. The pre-processing pipeline implements several critical optimizations. In step 902, process 900 performs Model Optimization(s). Process 900 implements automatic model optimization techniques, including, inter alia: pruning, quantization, and knowledge distillation. Process 900 can implement Memory Management in step 904. Sophisticated memory management systems implement automatic batch size optimization and gradient checkpointing for efficient resource utilization.

In step 906, process 900 implements LoRA Implementation(s). Process 900 implements Low-Rank Adaptation techniques for efficient model fine-tuning on resource-constrained devices.

In step 908, process 900 provides User Interface Implementations. The implementation includes both API and no-code interfaces. API Implementation can include RESTful APIs that provide programmatic access to all system functionality, implementing comprehensive documentation and version control.

In step 910, process 900 provides a No-Code Interface. A visual interface implements drag-and-drop functionality for common AI/ML workflows, including model training, fine-tuning, and deployment.

Performance Optimization is now discussed. Unified Computing Interface System 500 can manage several layers of performance optimization as shown in FIG. 10, according to some embodiments. FIG. 10 and FIG. 5 can be combined together as well as with other systems provided herein in various embodiments. Automatic Scaling layer 1002 provides predictive scaling algorithms that anticipate resource requirements based on historical usage patterns. Load Balancing layer 1004 performs sophisticated load balancing algorithms that distribute workloads across available nodes for optimal performance. Cache Management layer 1006 provides implementations of distributed caching systems for frequently accessed models and datasets.

Monitoring and Maintenance is now discussed. Unified Computing Interface System 500 can perform comprehensive monitoring and maintenance systems. This can include real-time monitoring of system performance metrics across all nodes and components. This can include the implementation of automatic update and maintenance procedures for system components. This can include automated Error Detection. Sophisticated error detection and reporting systems can provide rapid identification of potential issues.

Example Deployment Considerations are now discussed. Unified Computing Interface System 500 can implement robust networking infrastructure to support distributed computation. Unified Computing Interface System 500 provide Storage Management systems. These can use distributed storage systems for model artifacts and training data. Unified Computing Interface System 500 include automated Scaling Considerations that plan for system growth and resource expansion.

Unified Computing Interface System 500 represents a sophisticated solution to the challenges of distributed AI/ML workload management. By carefully considering each component's implementation details and their interactions, the system provides a robust platform for scaling AI/ML operations across heterogeneous computing resources while maintaining security and performance requirements.

### Conclusion

Although the present embodiments have been described with reference to specific example embodiments, various modifications and changes can be made to these embodiments without departing from the broader spirit and scope of the various embodiments. Accordingly, the specification and drawings are to be regarded in an illustrative rather than a restrictive sense.

What is claimed by United States patent:

1. A distributed computing system for artificial intelligence workloads, comprising:
a core orchestration server configured to manage a distributed network of heterogeneous computing devices;
a node registration module configured to:
detect capabilities of computing devices requesting to join the network;
perform automated benchmarking of said computing devices; and
register validated devices as network nodes;
a security layer implementing:
TLS certification;
node authentication protocols; and
workload isolation protocols;
a workload scaling module configured to:
analyze job requirements;
match said requirements with available node capabilities; and
distribute tasks across the network nodes;
a smart container orchestrator configured to:
deploy containerized AI/ML workloads;
monitor workload execution; and
maintain workload operations across the network nodes;
wherein said system enables distributed processing of AI/ML workloads across heterogeneous computing devices.

2. The system of claim 1, further comprising:
a pre-processing pipeline configured to:
optimize AI models for distributed execution;
implement automatic batch sizing;
implement Low-Rank Adaptation (LoRA); and
manage memory allocation across network nodes.

3. The system of claim 1, further comprising:
an interface layer providing:
an API for programmatic workload submission;
a no-code visual interface for workload management; and
real-time monitoring capabilities.

4. The system of claim 1, further comprising:
a fault tolerance system configured to:
detect node failures and network issues;
automatically redistribute workloads from failed nodes;
maintain system reliability through redundant operations; and
implement recovery procedures for system restoration.

5. The system of claim 1, further comprising:
a cost management module configured to:
track resource usage across network nodes;
calculate usage costs based on predefined metrics;
manage payment distribution to node providers; and
maintain usage records for billing purposes.

6. The system of claim 1, further comprising:
a dynamic load balancing system configured to:
monitor real-time network conditions;
track node performance metrics;
optimize workload distribution based on current conditions; and
adjust resource allocation dynamically.

7. The system of claim 1, further comprising:
a model management system configured to:
maintain version control for AI models;
store and retrieve trained models;
manage training checkpoints; and
distribute training data across the network.

8. The system of claim 1, further comprising:
an SLA monitoring system configured to:
track workload performance against defined requirements;
implement priority-based scheduling;
enforce service level agreements; and
adjust resource allocation based on SLA requirements.

9. A method for managing distributed AI computing resources, comprising:
receiving registration requests from heterogeneous computing devices;
performing automated capability detection and benchmarking of said devices;
registering qualified devices as network nodes;
receiving AI workload submissions through an API or visual interface;
analyzing workload requirements and available node capabilities;
distributing workloads across appropriate network nodes;
monitoring workload execution and system performance; and
implementing automatic failure recovery procedures as needed.

10. The method of claim 9, further comprising:
predicting resource requirements based on historical patterns;
automatically scaling network capacity to meet predicted needs;
optimizing data transfer through caching mechanisms; and
maintaining system telemetry for performance analysis.

11. A system for automated environment management in distributed AI computing, comprising:
a configuration management module configured to:
analyze runtime requirements for AI workloads;
verify GPU driver compatibility across nodes;
manage software dependencies; and
implement automatic environment configuration;
wherein said system enables consistent workload execution across heterogeneous computing devices.

12. The system of claim 11, further comprising:
a disaster recovery system configured to:
maintain backups of critical system data;
preserve AI models and training progress;
implement recovery procedures; and
ensure business continuity during system failures.
